(19) United States
(12) Patent Application Publication
(10) Pub. No.: US 2021/0279577 A1
(43) Pub. Date: Sep. 9, 2021

(54) Testing of Computing Processes Using Artificial Intelligence

(71) Applicant: Seva Development, LLC, Sandy, UT (US)

(72) Inventors: Peter Gardiner West, Eagle Mountain, UT (US); Daniel Moroni Hair, Eagle Mountain, UT (US); Jeffrey Douglas Handy, American Fork, UT (US); Michael Ray Kimball, Sandy, UT (US); Daniel James Ricks, Pleasant Grove, UT (US)

(73) Assignee: Seva Development, LLC

(21) Appl. No.: 17/192,651

(22) Filed: Mar. 4, 2021

Related U.S. Application Data
(60) Provisional application No. 62/985,151, filed on Mar. 4, 2020.

(51) Int. Cl. G06N 3/08; G06N 3/04

(52) U.S. Cl. CPC G06N 3/08; G06N 3/04

(57) ABSTRACT

Technology is described for generating tests to execute against a process. The method can include identifying a data store of input operation requests for the process, and the input operation requests are recorded for requests received to operate functionality of the process. Another operation can be training a deep neural network model using the input operation requests to enable the deep neural network model to generate output series based in part on the input operation requests. Test series can be generated using the deep neural network model. The test series are executable to activate functionality of the process in order to test portions of the process. A further operation may be executing the test series on the process in order to test functionality of the process.

### BACKGROUND

Software defects may cost the US economy up to a 1.7 trillion dollars a year, and the cost of software defects has been growing every year. These software defect costs may be even greater on a world-wide basis. These same defects affect billions of customers and consume hundreds of years-worth of developer time from the computer industry. The “ideal” rate of software releases has also been increased from semi-annual to monthly, to weekly, and now to multiple times per day. As the rate of software releases increases, quality becomes an increasingly difficult challenge.

Improving efficiencies in software development has become important in order to meet the demands of consumers. The stages of software development may include gathering and analyzing the requirements for the software, designing the software, implementing the design in code, testing, deployment, and/or maintenance. Efforts have been made to improve efficiency in each of these areas. More specifically, large efforts are constantly put into software testing in an effort to curb software defects. For example, at the testing stage, teams of engineers may write test scripts for each new piece of code. The teams may change the test scripts as the code is updated, and the teams may triage test results manually. Despite the extensive efforts already underway in software testing in most areas of software development, the creation of software defects continues at an increasing rate.

### BRIEF DESCRIPTION OF THE DRAWINGS

FIG. 1 is a block diagram illustrating an example of an automated test generation system.

FIG. 2 is a block diagram illustrating a more detailed example of a test automation and triage system.

FIG. 3 is a flow diagram illustrating a test series generation flow chart for a software test automation and triage system.

FIG. 4 is a block diagram of a system illustrating an example of a triage engine for a test automation and triage system.

FIG. 5 illustrates a graphical user interface of a process with highlighted portions representing testing coverage for the process.

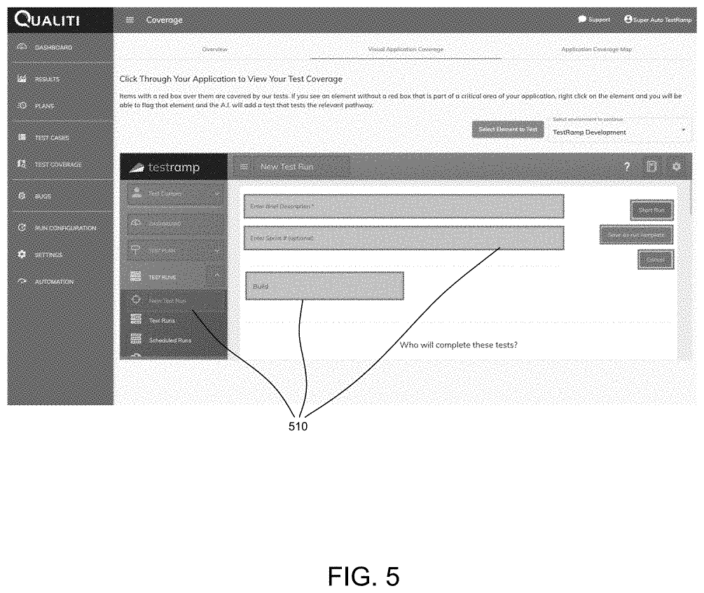

FIG. 6 is a flow chart illustrating an example of a method for generating, executing and validating software tests.

FIG. 7 is a flow chart illustrating an example of a method for determining whether test outputs have valid behavior.

FIG. 8 is a block diagram illustrating an example of a service provider environment (e.g., a public or private cloud) upon which this technology may execute.

FIG. 9 is a block diagram illustrating an example of computer hardware upon which this technology may execute.

### DETAILED DESCRIPTION

The software testing industry has been trying to apply Automated QA (Quality Assurance) using A.I. (Artificial Intelligence) or machine learning to improve QA testing, but the industry today seems far from viable solutions in this area. Automated software testing, ironically, is an extremely time-consuming process in which Software Development Engineers in Test (SDETs) spend much of their work time writing, maintaining, and triaging scripted tests. Attempts to simplify this process with so called codeless automation or “click and record” automation may have actually increased the time consumed in the testing process, while resulting in, for the most part, less stable overall tests. In addition, maintenance and triage seem to be the most time-consuming elements of the testing process.

The majority of the time, money, and effort spent in software testing goes into verification of existing functionality (e.g., regression testing), which most organizations are trying to accomplish via automated testing. Current attempts to use A.I. in software testing have fallen short, yet this has not stopped companies from spending millions on machine learning style agents to crawl their applications to find defects but with little success.

This technology may automatically generate test cases to be executed in order to test functionality of a process. The test cases generated may include long-lived, useful test cases that can be stored in a data store and used over many builds of a process being tested. The test cases can be generated using machine learning models similar to deep neural network models used in the area of natural language processing (e.g., in text generation and text comprehension). Such deep neural network models, often based on transformer type architectures and deep neural network models, have shown consistently valuable results when being trained in human languages and generating output in human languages.

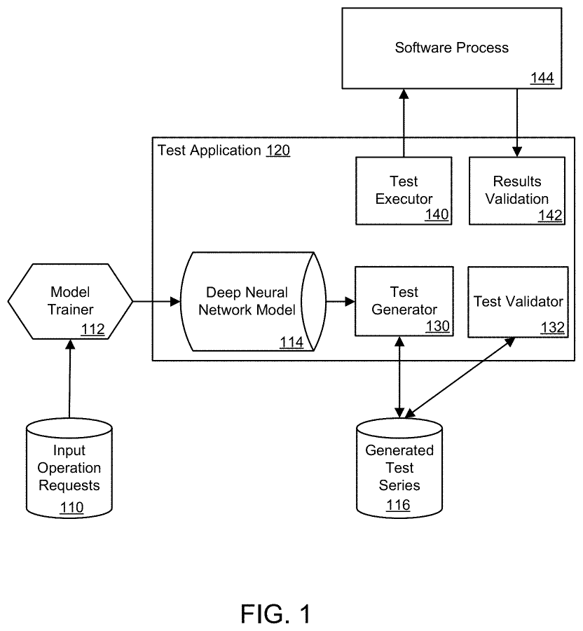

FIG. 1 illustrates that this technology can treat input operation requests 110 to a process or the process behavior (e.g., output) as an unstructured language. The words in the process' input operations language and output language are not nouns, verbs, adjectives, or other parts of speech. Instead, they are input request events, output events, user interaction events, database updates, HTTP requests, server logs, and similar input and output events.

In one example, the input operation requests may be recorded in user interaction sessions that represent user interaction events which may be interactions with graphical controls, command line controls, user interfaces or other control interfaces of the process 144 or software process. In another example, the input operation request may be received from another process (e.g., API calls). The input operation requests may form a user test series that tests a portion of the process' functionality, as recorded from a user during a testing session.

In one configuration, the input operation requests may be captured solely from visual data recordings captured for the frontend of the process. The elements on an electronic page may be identified visually and assigned a generated identifier (ID). The graphical data recordings or visual capture of the input operation requests enable testing of any type of process 144 on any platform regardless of underlying code structure or source code language. The process 144 may be an application, an operating system, a driver, a service, middleware, a database process, a thread or any type of process.

Test generation is possible when a deep neural network model 114 is trained using a model trainer 112 with input operations requests (e.g., test input) that have been recorded using input from human testers, input from other programs (e.g., API service requests at a service in the cloud) or graphical user input from general users. In generating test cases, the deep neural network model 114 can be trained with input operating requests using the language of the input events or user input events, which has a manageable variance as compared to other complex languages. This reduced variance means reduced combinatorial explosion in the input and output. In test generation, the reduced variance may mean that accuracy and precision are improved even with smaller amounts of training data, allowing test generation to begin shortly after initially testing a new process or service.

Test series may be generated using a test generator 130 (e.g., a test generation module or test generation logic) in the test application 120 and the plurality of test series may be stored in a generated test series data store 116. The data store may accumulate the input operation requests received by the process 144, which have been recorded for users or processes utilizing the functionality of the process 144. The test generator 130 may generate one or more test series using the deep neural network model 114 (e.g., an attention-based deep neural network model). These generated test series may be able to activate functionality of the process 144 and to test portions of the process 144.

Some machine learning models used in this technology may also be trained as to how the test series or test input should behave using the corpus of input operation requests 110. This training allows the test series to be validated and provides the ability to identify what tests are both useful and valid. The test may be validated using the test validator 132 in the test application 120. The test validator 132 may validate the one or more test series with a machine learning model used as a classifier to classify whether a test series is executable on the process 144. In one example configuration, a natural language processing model such as BERT (Bidirectional Encoder Representations from Transformers) may be used to validate a test series through a machine learning model that is trained on input operation requests (e.g., events) or user events in order to evaluate a test's validity. If the execution probability of the test series falls above a test execution threshold value, then the test series may be validated as a good test. If the execution probability of the test series falls below the test execution threshold value, then the test may be discarded or flagged to a user as a test that does not conform to acceptable behavior for the process 144.

Another way to validate a test or test series is to execute the test on the process 144 to determine whether the test executes. If the test completes then the test is a valid test. If the test does not complete, then it is not a valid test. However, the test may be modified in triage and re-tested to see if the test will execute.

One or more additional machine learning models may be trained on the full array of application output events including the server logs, database updates, and more to evaluate whether the output behavior of a test was valid output behavior for the application. For example, a results validation module 142 in the test application 120 may contain a trained machine learning model to validate the output of a process 144 upon which tests are being executed by a test executor 140. Being able to evaluate output behavior allows for even better test generation, more realistic interactions and automatic defect fixes. This automated test triage can take steps to correct problems in test series without human intervention. Evaluation for automatic fixes may be possible by comparing the behavior of the process 144 with failed or mutated code to the expected behavior for the process as defined by a developer who has created similar test series for process elements.

Another aspect of this technology is using the data from the process 144 (e.g., frontend and/or backend data) to identify feature flags in the interface of the process 144. By identifying flags or data that affects the elements that are present in electronic pages, the ability to handle feature flags and AB testing may be provided. There are elements (e.g., a button or grid) or outputs from the process that will only be provided when an attribute, key or variable with a value on the backend (e.g., a database) or on the frontend (e.g., from web pages, configuration files, hard coded constants, a third-party service, etc.) manifests that value. As a result, some test series can only execute when a certain value is present. The test application can run a test when a certain value is present and will not run a test when the value is not present. The testing application can check the environment for the desired key and value first and then run the test when the value is available.

Load testing is another crucial tool in software testing today that depends on the ability to simulate real users in order to understand how an application handles large user bases or usage spikes. The test generation techniques described herein can be used to simulate more realistic automated users and create better automated load testing with a large number of simulated users.

Useful test generation and validation results may be obtained using a machine learning model that is an LSTM (Long Short Term Memory) type RNN (Recurrent Neural Network). A GPT-2 or BERT machine learning model may also provide useful results. The data, data format, and an attention-based transformer-based model for test generation can be useful in test evaluation or validation. The test application 120 and technology pipeline for the test application 120 can: a) identify data related to a process, b) use selected machine learning models in test generation and test triage, c) alter the output layer of the test generation machine learning model to mask invalid actions for current application states, d) fine-tune these models to achieve a sufficient level of accuracy for useful test generation and triage, and e) implement a reinforcement learning agent to increase test coverage and reduce redundancy.

As mentioned earlier, this technology may use Natural Language Processing (NLP) types of machine learning approaches to test the process (e.g., application). The input operation request language and/or output data language for a process can be treated as unstructured languages. The “words” of the input language and output language for a process may be input events (e.g., user interaction events, API requests, etc.) and output events (e.g., log writes, API calls, etc.) with a process 144. Examples of the user interaction events may include: clicking on a specific button or typing in a specific field, or even dragging elements in a given way. These input events or output events can be the text corpus that is used to train an NLP type of machine learning model. More specifically, models such as GPT-2 and BERT are able to learn on languages, and then are capable of generating a next element in data series (e.g., text) or solving comprehension tasks. Once trained on a text corpus of input operation requests to the process, the models can generate test steps and test series taking into account the context of how the process is desired to behave in a specific instance. The present approach may solve both test generation and the oracle problem in software testing.

While a variety of deep neural network models may be used, transformer-based models such as BERT (as well as the related models Albert, RoBERTa, DistilBert, ERNIE 2.0, and more), GPT-2 and related models (CTRL, XLNET, DistilGPT2, Megatron, Turing-NLG, and more) have been found to be useful for the present technology. These trained self attention-based models, including the use of a transformer architecture may be used to generate test cases. Instead of the ability to generate a simple test that may result from an LSTM approach alone, a test series or input requests that build on each other may be generated.

The testing application may take the existing machine learning models and mask output vocabulary so as to only select appropriate potential next steps from the training dataset, and so, the models are consistently more likely to output a valid series of steps. Realistic test steps of a fixed length may be generated using this technology. Further, variable length tests may be generated when a large enough training dataset is used for training. The tests can follow actual patterns users would take, without being actual copies of any of the user input data. The model does not just memorize the input data and output the same data, but the tests are unique sequences of valid test operations or actions. In some configurations, realistic test sequences are generated only once in every few samples. However, a BERT-like model can be used to identify realistic versus non-realistic tests and so unrealistic test sequences may be discarded.

An input step or first step may be provided in order to generate a valid test. For example, the model may be given a set of initial starting points. In a further approach, previous valid tests are fed into the machine learning model as the input, allowing for even more success as context increases for chained or related, but not overlapping, test cases. A reinforcement learning agent may be used to determine good inputs to provide for the most test coverage with the lowest test redundancy. The reinforcement learning agent can adjust both input and even slightly modify the probability distribution of the output from the GPT-2 like model.

This technology may reduce defects, allow for quicker release times, and free-up the time of in-demand engineers. Today, labeled data is incredibly expensive due to the thousands of hours many companies spend paying people to label images, text, and more. With the present technology, labeled data or an expensive to implement self-training agent may be reduced or even avoided completely. Any sequential type of interaction with a process, whether it be a small software company trying to automate a given process or task, or an industry-disrupting effort leveraging A.I., can now be tested more effectively using this technology. Without this technology, only medium to large enterprises can generally afford continuous testing, which has required large teams of automation engineers, and even then, full test coverage is not feasible. Instead, this technology provides greater test coverage across a process' functionality than would be available using recorded scripts.

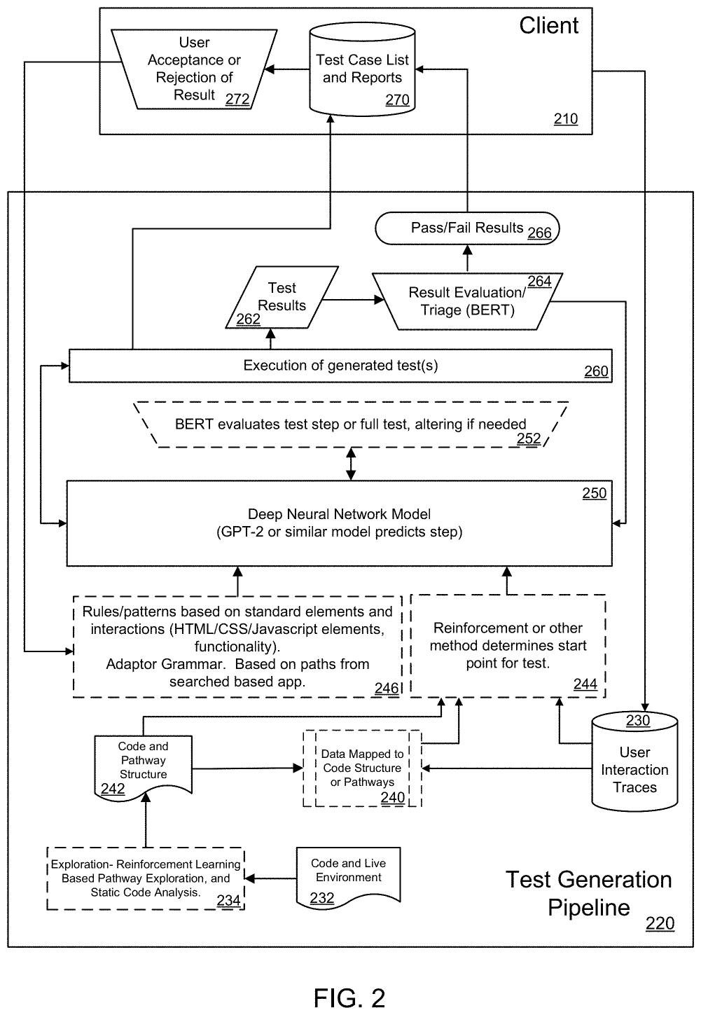

FIG. 2 illustrates a software test automation and triage system as a block diagram showing data flow, according to one configuration of the technology. The system may include a client 210 and a test generation pipeline 220. The client 210 may execute on a client device. The test generation pipeline 220 may include a test application installed on the client device, or the test application may be installed on a device such as a server that is separate from the client device.

In one example, the test pipeline 220 may be configured to test the functionality and/or performance of a process. An application or a subject application may be an example of a process. The application may be, for example, a software application for use by a customer, such as a business application, web application, a data collection application, a search results application, a productivity application, a navigation application, a media application, a game application, and so forth.

A trained machine learning model 250 may be used by the test generation pipeline 220 or test application to generate test cases or test series and ultimately test results from a process. The test results can be used to analyze the functionality and/or performance of the application. The client 210 may inform the test results, and the informed test results may be fed back into the test pipeline 220 to further train the machine learning model 250.

In various configurations, the test automation software or test generation pipeline may write, run, and/or triage test automation for the test engineers or other users. The test automation software may do this by analyzing how real users (e.g., a human such as an end user, an engineer, a tester and/or others) interact with the platform, and the test automation software may be trained regarding how the process may be intended to behave. Various inputs and outputs for the process may be recorded. For example, types of interactions that may be recorded may include: interactions with a process, output the interactions triggered in the process frontend, interaction with a process programming interface (API), HTTP requests sent out by the process, interactions with a backend server, and/or a backend database, etc. The interactions may be recorded via an embedded script, library, instrumentation, package embedded in the process, and/or separate package monitoring the process. Resulting data recorded from the interactions may be used to train a deep neural network model or similar machine learning model.

As discussed, process data and/or associated process behavior may be gathered from the process (e.g., application). The process data may include ways in which a user or another process interacts with the process. The process behavior may include responses from the process or outputs from the process. The process data and behavior may be passed to a machine learning model to train the machine learning model on how the process is expected to behave in light of the process data. More specifically, the test pipeline may record how one or more users engage with (i.e., use) the process to create a data store user of interaction traces 230. These user interaction traces 230 can be used to train a deep neural network model.

The test pipeline may include a machine learning model 250. The machine learning model may be a deep neural network model or an attention-based deep neural network model. The attention-based aspect of the model may refer to including other data being used as inputs before and/or after data of interest to inform the model about how the data of interest is interpreted. The attention-based machine learning techniques for testing the subject application may utilize the “attention” capability of NLP (natural language processing) approaches to allow a test application with a test generator and a deep neural network model to analyze a context of user actions. This context input may be used in order to generate the next item in a test series (e.g., actions for the process being tested) that the deep neural network model deems to be the most likely next element in the series (e.g., the next test operation). In one example, the deep neural network model may be a transformer-based model such as GPT-2. Using transformer or variational autoencoder, or encoder/decoder models may enable the test generator to make predictions about how a user would actually behave in the process. The deep neural network model 250 may be located on a server with the test application, or the deep neural network model 250 may be accessed at a separate location (e.g., located in a cloud service, separate server, etc.) and may be a separate application, separate service, or separate product. The test application may tell existing text execution tools (e.g., test runners) such as Cypress, Selenium, and/or a built-in agent to later execute test steps in the process being tested.

In one example, the input operation requests described earlier, may be considered user interaction traces 230 where the actions of users are tracked as a process is used. The user interaction traces 230 may be fed into the deep neural network model 250 or machine learning model. The commands and/or data entered into the interface of a process (e.g., an application) can be treated as an unstructured language and use NLP (natural language processing) processing models to improve automated testing. The commands and/or data can be stored as user interaction traces 230 in a local database or in a data store in a private or public cloud.

Process code and a live code environment 232 may be fed into a reinforcement learning module 234. The test pipeline may optionally include static code analysis, search-based application exploration, and/or reinforcement learning-based pathway exploration 234. Execution pathways for the subject application may be identified using reinforcement learning 234 or other search processes. The test pipeline may accept code structure or execution pathway information about the subject application. Information about the subject application passed to the deep neural network model or similar machine learning model may include a pathway structure or execution paths 242 for the application code. The information may include data mapped to the code and/or data mapped to the structure and/or pathways of the code 240. The data mapped to the subject application code structure and/or pathways 240 may optionally be fed into the deep neural network model 250 (e.g., the attention-based machine learning model).

The data collected to train the deep neural network model may generally include time series data where the data is organized with respect to time, sequence or order. Accordingly, the machine learning model may be configured to handle time-series data of variable length, e.g., data where order and sequence matter, patterns and context matter, but the length of input is not fixed. The time series data may include data fields in a tuple or record that are: a time stamp, session data, a user interface element being activated, a function type being applied, data to be entered, or an area of an interface being activated.

In one example, machine learning models (e.g., deep neural network models) may be trained on the time-series data and then used for test generation. The deep neural network model may be used to predict a “next” step or series of steps, or predict what step should go in a certain part of a series of steps. In particular, transformer, encoder-decoder, autoencoder, variational autoencoder, attention-based neural net, LSTM based (or other) recurrent neural network (RNN), a convolutional neural net (CNN), and/or other similar machine learning models may provide such prediction functionality. A common component of these models is that the models create vectors that represent pieces or groups of the input/training data, or data from a previous layer, and those vectors may be passed into (and modified by or copied by) the layers of the models, whether to encoder and decoder layers, a word2vec like approach, n-grams, masked language modeling, next word prediction, or other approaches.

The data collected to train a deep neural network model may also be linked with user session data. This allows the data to be separated into time ordered data by user session. In one configuration, the events from the fronted and backend events may be organized by user session ID and/or by timestamp. This allows the events to be used in log or performance monitoring too. Organizing events by timestamp and session also enables grouping in the logs by interaction and feature, not just timestamp. Grouping events by feature or user session enables users to view events in a group that are actually being applied to individual elements of a process. More specifically, the data collected can be identified by a portion of the process being tested, such as a button, menu, feature, etc., and the tests can be organized by feature. For example, all the server logs for the “add to cart function” in an electronic commerce application may be viewed together. Reporting may also be provided by a specific type of interaction. In another example, the logs may be grouped by user types because the session information indicates what type of user the individual is (e.g., basic, intermediate, advanced, or accounts payable, shipping, etc.). The user session data may also be used to identify groups of users that have a certain security level or use specific features in the process.

A reward method, such as a reinforcement learning algorithm 244, may determine a starting point for a test of the subject application. This approach for generating test series (e.g., a test case) may focus on an initial starting state in the subject application and what next step would give a highest “reward” or “punishment” using reinforcement learning. Using reinforcement learning or reward methods are optional. Alternatively, human selected starting points or random starting points may be selected.

Additional information regarding the rules and/or patterns of the structure of the elements 246 of the process, such as standard elements (HTML, CSS, JavaScript, object hierarchies, data store structures, etc.) or standard interactions may optionally be fed into the machine learning model 250. The process and/or interaction information may be passed through, for example, an adaptor grammar model before being passed to the deep neural network model.

A deep neural network model trained on data related to a process (e.g., a subject application) may generate test series and/or test steps to test the process (e.g., subject application). Those test series and/or sets of steps may be executed with an agent, test tool, test runner and/or even manually. When a test of the process is executed 260, then the test results 262 may be output. In some configurations, each test series may be considered a separate unit or a test script.

In one example, a test bot (e.g., a software agent or test runner) may initiate tests or events associated with the application data similar to how a user may engage the process. The test bot may monitor the behavior of the process in response to the events initiated by the test bot, and may similarly identify elements of code associated with the process and the events. When the behavior of the process does not align with behavior expected by the test bot, the test bot may identify a portion of the code associated with the unexpected behavior and flag a problem with the code (e.g., the test did not pass). Alternatively, the test bot may repair the code so that the application behaves in accordance with the expected behavior.

Test results 262 from the test execution may be evaluated, such as by a separate machine learning model using classification. For example, BERT, GPT-2, regression, or other machine learning classifiers may be used for evaluating output data. Any identified bugs may be presented to a test engineer and/or user. As illustrated in FIG. 2, the test results 262 may be evaluated and/or triaged by an evaluation model 264. The evaluation model 264 may determine whether the test results conform with expected behavior of the subject application. The evaluation model 264 may be located on a server with the test application, or the evaluation model may be accessed at a separate location (e.g., located in a cloud service, separate server, etc.) and may be a separate application, separate service, or separate product. Results of the evaluation model may be passed back into the contextual machine learning model. For example, pass/fail results 266 for a test case list, as determined by the evaluation model, may be output and communicated using a report 270 to the client. Other types of result may be reported too, such as warnings, informational results, flags, etc. The user may accept and/or reject the results 272. The client acceptance and/or rejection of the results may be fed back into the machine learning model 250.

While executing tests, the test application may record the resulting events received from the subject process' frontend and/or backend. The recorded event data may be used, in conjunction with a result of the test that was run to decide if a test passed or failed 266, or if the test failed due to problems with the test or the test environment rather than the process. More specifically, an attention-based transformer model may be used to decide if process output was a valid output or if the output behavior did not match the expected process behavior. For example, a transformer and/or encoder-decoder approach may be used for testing, such as GPT-2, BERT, and so forth. A further operation may include presenting bugs to developers and/or testers. The developers and/or testers may label a bug as not a valid bug or a test that should not have failed, which may further train the machine learning models described.

Testing triage 264 may include various processes for checking the output of the automated tests applied to a process. Testing triage 264 may include forming a record of past behavior and results of the process including past labels from the end user that marked a test result as approved/confirmed, rejected, and/or invalid. The testing triage may further identify common defects (e.g., 404 error) and/or rules (e.g., data from group submit buttons should result in a specified behavior) automatically. The triage system 264 may then recommend automatic bug fixes based on code mutations. For example, the triage system may compare previous invalid behavior to new process behavior recorded by a developer or tester and update the test with valid behavior, which may lead to a new test generation. In addition, clustering may be used to evaluate test results based on the recorded/generated data.

In one optional configuration, test validation using a deep neural network model 252 may evaluate the test(s) generated by the primary deep neural network model 250 after the test has been generated but before the test has been executed. The test validation deep neural network model may alter the test and/or may feed the alterations back into the primary deep neural network model to update the primary deep neural network model. In one alternative configuration, the altered tests may not be fed back into the model as feedback but the altered tests may be saved to the test list. In some cases, the test may be unaltered by the test validation deep neural network model, and this information may be fed back into the primary deep neural network model.

The evaluation models, deep neural network models, reinforcement models, reward/penalty models and so forth, as described herein may include techniques adapted from the field of natural language processing (NLP). Specific models may which may be used with the test environment include: the generative pre-training model (GPT, GPT-2, etc.), the bidirectional encoder representations from transformers model (BERT), the conditional transformer language model (CTRL), a lite BERT model (ALBERT), the universal language model fine-tuning (ULMFiT), a transformer architecture, embeddings from language models (ELMo), recurrent neural nets (RNNs), convolutional neural nets (CNNs), and so forth.

The test application can also identify user permission level groups using clustering of user interactions and by identifying which elements are available exclusively to users in a given group. Users may be allocated to defined groups because the test application can see certain groups of users who never hit certain functionalities, paths or UI controls while other groups of users often do access those functionalities, paths or UI controls. The clustering of user interactions may reveal that user group Y only accesses application elements in area Y, while user group Z accesses elements in application areas Y and Z. This access pattern may indicate that the security rights the two different groups are different. For example, the test application can identify a differentiation between admin users vs. regular users or users of application area Y vs. area Z. Thus, the test application can execute a test to verify that a user that should not have access to electronic page N really cannot not access page N by executing an automated test that has the user try to access page N with the wrong login. Thus, the test of electronic page N should correctly fail and this tests the application more completely.

Appropriate support methods for data processing and machine learning models may be used by the test application and may include techniques in processing sequential data, such as text processing, language processing, speech signal processing, video processing, or other sequential data processing processes. In addition, NLP approaches directed at language modeling may be useful in text generation, language translation, text summarization and/or question answering. Such models may include machine learning models that pay attention to context (beyond current/immediate state), especially left to right context and bidirectional context. The techniques may be used to identify, in context, how the process is used. LSTM approaches with some degree of feedback may work as described earlier. Attention/self-attention may be an element of useful configurations for the test application, especially in the use of transformer architectures in the test application. An encoder-decoder approach and/or transformer approach may provide successful results. The training of these models may be self-supervised training, meaning they do not require constant human input or labeling of all data for training. Accordingly, the test application may result in reduced human input for application testing relative to other previous solutions.

Examples of the types of data that may be included in the test application data may be:

1. Time-series Data
a. Clickstreams (Input)
b. Server logs (Output)
c. Database updates (Output)
d. DOM/POM updates (Output)

2. HTTP Requests (Output/Input)

3. Remote function calls (Output)

4. Screenshots and screen recordings (Output/Input)

5. Other visual data (OCR'd text, colors, etc.) (Output/Input)

6. User stories and UI mockups (optional) (Input)

7. Performance metrics (CPU, memory, or time-based metrics) (Output)

This list of types of data above that may be used by the test application is not a comprehensive list of types or combinations of data that can used in the test application and should not be considered limiting. For example, in the case where the input operation requests are captured using visual data or visual screenshots then the clickstreams may not be necessary. Further, any other types of data inputs or data outputs related to the process may be recorded or analyzed and used in the test application as needed.

The test application may generate real, relevant, and/or useful test cases and/or scripts which are able determine whether a test of the process (e.g., subject application) fails. As a result, the test application may reduce the amount of time spent writing, maintaining, and/or triaging tests relative to previous solutions. The test application may take into account a context of the test steps being generated based on the machine learning model's knowledge of the context operations for any operation in the subject application. The test application may test a process in the same way a user may use the process (e.g., application) because the test series that are automatically generated can resemble actual user tests. For example, the test application may interact with the subject application as if the test application were a real user and/or engineer, effectively acting in place of thousands of users and/or engineers to provide load testing.

The client 210 and/or the server may include a processor and/or memory. The client application and/or the test application may be installed in the memory. The processor may execute steps of the time-based test application. The client device and/or the server may include networking hardware such as communication chips, network ports, and so forth. The client device and the server may communicate via the networking hardware. For example, the client may execute a subject application for testing by the test application, or the server may communicate steps of the test application to the client device for execution by the subject application. The client device may communicate behavior of the process back to the server in response to the steps. The networking hardware may be wired, optical or wireless networking devices. The electronic signals may be transmitted to and/or from a communication line by the communication ports. The networking hardware may generate signals and transmit the signals to one or more of the communication ports. The networking hardware may receive the signals and/or may generate one or more digital signals.

In various embodiments, the networking hardware may include hardware and/or software for generating and communicating signals over a direct and/or indirect network communication link. For example, the networking hardware may include a USB port and a USB wire, and/or an RF antenna with BLUETOOTH installed on a processor, such as the processing component, coupled to the antenna. In another example, the networking hardware may include an RF antenna and programming installed on a processor, such as the processing component, for communicating over a WiFi and/or cellular network. As used herein, “networking hardware” may be used generically to refer to any or all of the aforementioned elements and/or features of the networking hardware.

In various embodiments, the server may include an application server, a data store, a web server, a real-time communication server, a file transfer protocol server, a collaboration server, a list server, a telnet server, a mail server, or other applications. The server may include two or more server types. The server may include a physical server and/or a virtual server. The server may store and execute instructions for analyzing data and generating outputs associated with the data. In an embodiment, the server may be a cloud-based server. The server may be physically located remotely from the client device.

In various embodiments, the client device may include a mobile phone, a tablet computer, a personal computer, a local server, and so forth. The client device may send requests to the server for information, data, and/or action items associated with the test of the subject application. The server may send the requested information, data, and/or action items to the client device. The information, data, and/or action items may be based on processing performed at the server.

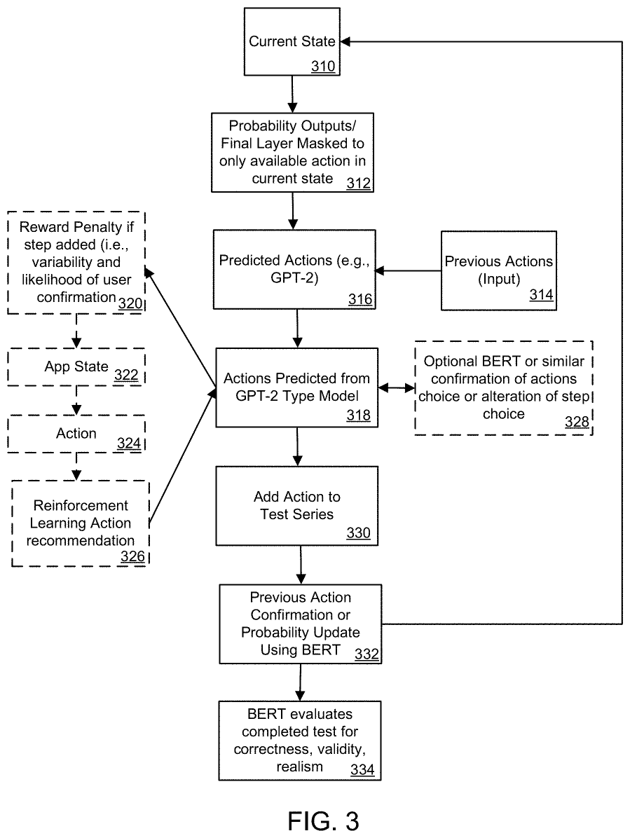

FIG. 3 illustrates a test series generation flowchart for a software test automation and triage system, according to an example. The training may, for example, enable a deep neural network model to generate tests to be applied to a process in order to evaluate the functionality and/or performance of the process.

In some configurations, the software test automation and triage system may include a deep neural network model, such as GPT-2 or a similar attention-based deep neural network model. A starting state for the process may be set as the current state 310. The starting state may be a first operation or first user interface action (e.g., a graphical control or command line input) or element to be accessed in the test generation process.

Probability outputs based on the current state 310 may be generated, which may mask the available actions in the current state 312 of the application. The outputs may be assorted into a probability distribution based on predicted actions, as in block 316. Alternatively, rather than giving a probability distribution of options, a single option may be output (e.g., a most probable option). The predicted action may be predicted by an action model 312 informed by previous actions 314 in the test series.

The probability distribution 316 may be fed into the deep neural network model 318. The deep neural network model 318 may generate an action as a test step or test operation of a test series being generated.

The test step may optionally be evaluated by a confirmation model 328. An example confirmation model may be BERT or another similar machine learning model. The confirmation model may alter the test step or confirm the test step is an appropriate operation. The confirmed action may be added to a set of test steps for the subject application, as in block 330.

In an optional configuration, a choice of the action may be refined by a reward/penalty model 320 and/or a reinforcement learning model. The action generated by the deep neural network model may be passed to the reward/penalty model 320. The reward/penalty model 320 may evaluate a variability of results of the action being performed by the subject application and/or a likelihood of confirmation and/or rejection of the action by a user. The reinforcement learning or other reward method can alter a test step to secondary probabilities if variations in the test cases increase, bug detections increase, etc.

An output of the reward/penalty model may be applied to a state of the application 322 to update the action 324 based on the reward/penalty output in the context of the application state. The action 324 may be fed into a reinforcement learning model 326. The reinforcement learning model may make a recommendation for the action and pass the recommendation to the deep neural network model 318. The action output of the deep neural network model may be updated with the recommendation for the action.

In one configuration, a dream environment (not shown) may be automatically formed to increase variation of circumstances probabilistically associated with the action. The dream environment may encompass various aspects of the process that are modeled in the dream environment. The action may be updated using the dream environment. The updated action based on the dream environment may be used to inform and/or update the reward/penalty model.

Once the final action has been added to the test series 330, the new action and/or the test series may be validated 332 using an additional deep neural network model, such as BERT. In addition, a BERT model may evaluate 334 the completed test series for correctness, validity and realism. While a test series is shown as being generated a single operation at time, an entire test series can be generated at one time and then validated.

To summarize, the deep neural network model may generate a set of test steps. The action may be added to the set of test steps. The set of test steps may be fed into a deep neural network model to confirm and/or update the set of test steps. The set of test steps may be sequential such that execution of a current action follows a previous action.

In some situations, the deep neural network model may update the previous action based on the current step. When the previous action is updated, the current step may be re-selected by the deep neural network model to confirm the current action. When test generation for the process is finished (e.g., when the deep neural network model has confirmed and/or updated all the test steps), a completion model may evaluate the test (e.g., all the steps) to determine a correctness, validity, and/or realism of the test. For example, the completion model may compare the test against how a user may use the subject application. Next, a test execution model may apply the set of test steps to the process.

As described before, the inputs into the machine learning models such as the deep neural network model may include: interactions with the process, behaviors of the process, API calls received by the process, HTTP service requests made to other processes (e.g., in the case of a cloud service), code of the process, code structures of the process, and/or code pathways of the process, and so forth.

In a further configuration of a test generation, a network graph of input interactions may be used to identify tests or test series that can be chained together in an extended test sequence. The test application can organize and link the tests using the network graph and the tests represented in connected nodes in the network graph. For example, one test may be that a user adds a product to the cart, but then checkout with the product is a separate test. The automatic test generation may join both tests for adding product to a cart and checking out together to create a new machine generated test series. The test application may infer that once a simulated user is at point A, then test B can be sequenced after test A because the operations of test B quite frequently come after A in actual use of the process. Similarly, the test application can join a base test with several alternative path connections that are common with a base test to form multiple tests based on the original base test.

Accordingly, interactions with, behaviors of, code of, code structures of, and/or code pathways of the process may be treated as a type of unique language where a first action associated with the process, when viewed in a context of a state of the process when the action is executed, is associated with a probability distribution of subsequent behaviors and/or responses. For example, a process input entered into the deep neural network model may output a probability distribution function associated with various requests or actions made to the process that correspond to a human use of the process.

Existing software test automation and triage may include teams of engineers writing test scripts for each new piece of code. These teams may have to fix those tests at every code update and then may have to triage the results manually. The result may be that for every one minute spent writing a manual test, 25 minutes are spent writing an automated test, 250 minutes are spent maintaining the automated test, and additional time is spent triaging defects every time the test fails. The result is thousands of hours of engineering time going into writing, maintaining, and then triaging the results of a set of test automation scripts. Even then, the engineers never are able to write automated scripts to cover anywhere near 100% of an application. Current attempts to use artificial intelligence (A.I.) to replace this existing process fail due to a lack of context and understanding of the application by artificial intelligence systems. These problems are overcome using the present technology to automate the tests applied to a process.

### Data Curation

Data curation is important to systems that leverage machine learning. In relatively small amounts of time, processes being tested or used by a moderate level of users are generating gigabytes of use data and output data every hour. With the present technology, this is enough data to achieve the results desired. For small companies without large numbers of users for a software, it may take, for example, a few more days up to a couple of weeks more to start using this technology. For test generation, the actual input operation requests (e.g., user actions, API requests, or inputs from other processes) are needed to simulate input behavior for the process. For understanding the behavior at a deeper level, however, other data may improve quality as well as the range of the process (e.g., application) that can be tested. Instead of just testing the UI functionality that the input operation requests create, understanding what is happening to a database, server logs, what HTTP requests are made, responses received, and similar events can help evaluate application behavior at a deeper level that previously used multiple forms of testing, most of which are overlooked by companies with limited budgets. In addition, the actual values associated with events matter, and understanding the type of data is important for realistic testing of a process can influence the complexity of testing projects.

The process of recording input operation request data or output events and data and the data format the data is recorded in can be optimized to ensure minimal to no impact on the end-user experience or process performance as data is recorded and sent to the training database. Base URL switching and similar tactics, along with anonymization, can be utilized to handle transition of data from a prod environment to a test environment. In addition, a useful tokenization approach may be selected. For example, BERT may leverage WordPiece embeddings while GPT-2 may use a bytepair encoding. Variations on these and other sub-word tokenization approaches are used in many existing NLP models. More recent models use different tokenization approaches, and some are more efficient or result in better text generation or comprehension than others.

### Test Generation

Many different machine learning models may be used for successful test generation. That being said, many models use more data for retraining than others, while some models are more efficient. DistilGPT2, for example, is computationally far less expensive than the full GPT-2 model. It is possible that multiple models may be selected, with a certain model architecture being used initially until a defined data volume is reached, and with a second, less compute-greedy model architecture chosen for longer-term use. The model selected can balance compute costs, required amounts of data, and performance metrics for a specific project.

Various benchmarks may be established for comparing test generation usefulness and success. These include metrics such as rate of valid test sequence generation, average valid length of valid sequences, test failure rate, as well as standard model comparisons such as overfitting the data. A testing project may not receive test output and results until after the minimum data threshold for testing a process is met. For most organizations, this may happen in a matter of hours or possibly days. For small organizations who only have developers and no live users, it could take a week or two to reach the minimum data volume desired for test series generation. This technology provides testing results as good as methods that require human maintenance to achieve similar results and provides cost savings and efficiency improvements.

### Test Failure Rate Improvement

Operations which may provide improved test quality are the masking of potential outputs to only valid actions in the current state and the addition of BERT for test evaluation and improvement. As mentioned earlier, one approach to improve test generation and reduce test failure rate is to mask any step in the output layer of GPT-2 that is not believed to be a valid or potential action in the current process state for the test case. While this masking function may use static analysis tools, a network graph, and/or a live agent stepping through the app as each step is defined, this masking reduces the potential actions of a given step from, for example, an average of roughly 3,500 different actions to an example reduced average of only 20 to 45 potential actions. The effect of the combinatorial explosion that the deep neural network model might otherwise deal with is drastically minimized by such masking operations, and the validity of tests generated may be improved as well.

Another piece of test failure rate improvement may be using BERT to evaluate realism and quality of the test steps and test as a whole. The test sequence can be given to BERT with a single step masked, one at a time, until all test steps have been masked. The BERT probability distribution or output prediction may be compared to that of the GPT-2 output to ensure the two models agree. Determining the degree of variance allowed between the two for test steps may also be predetermined in the system. The architecture of GPT-2 may be better suited for test generation, than BERT or models similar to BERT. However, BERT may be well suited for providing good context for any test operation. While this is a bit of an oversimplification, BERT can be better used for evaluating what test operation goes in a test series when the parts of the test series before and after the given masked operation are known.

Once each step has been evaluated, the test as a whole may be compared to actual user interactions to determine whether the test is indeed a valid test case. This is similar to the use case mentioned above of using BERT to evaluate the realism and quality of test series. The most real or valid test cases may be added to the test group or test data store for execution.

### Defect Detection Rate Improvement

As described earlier, a reinforcement learning algorithm may be leveraged to improve the defect detection rate. This reinforcement learning agent (e.g., Q-learning or SARSA) may increase test coverage by altering test inputs while decreasing test overlap and redundancy by altering probability output layer distributions within a specific range. An example of this would be for the agent to provide different starting points for test cases, determining when a previous test is a good input versus when a starting point that is similar to a new user session would make for a better input. The agent may then compare existing saved tests to the steps that are in the current test with the proposed outputs (the output layer of GPT-2). The agent would have the ability to switch the choice of a step from the top probability to the second or even third choice if the probability of the choice is still above a given amount and if the first and second choices have been used already in another test. This amount or threshold will depend on testing or customer input for the variance level desired. The range of judgment the agent should be given or how low of a percentage choice the agent is allowed to cause the step to switch to, may vary across processes (e.g., applications).

By rewarding the agent for increased coverage and test variability, while providing punishment for redundancy and escaped defects, the agent can learn the best path to creating a more successful test set. Minimizing escaped defects may use input from users for any defects found after the system runs tests, and/or a tester may be informed by the system that the test case in question failed to find a defect at a given location.

In an alternative configuration to increase test coverage and decrease defect detection rate, a method can be used that compares the test coverage to current tests. Then the test application can select starting points in the process based on areas in the network graph or a similar structure that have not been tested and use those as a starting point to generate a new test.

### Test Execution

Various engines exist for test automation that can use the test steps and can be leveraged for this task. Automated conversion of the test series steps to a runnable format for the test engine may also be provided. While it is generally straightforward for a simple script to convert element identifiers and events to a runnable format, test steps can be manually entered into a test tool if desired. The events and other chosen data for the process being tested can be recorded for the tests. Recording the input and output data during test execution can also be manually triggered. This may be the data by used by the test triage.

### Test Triage

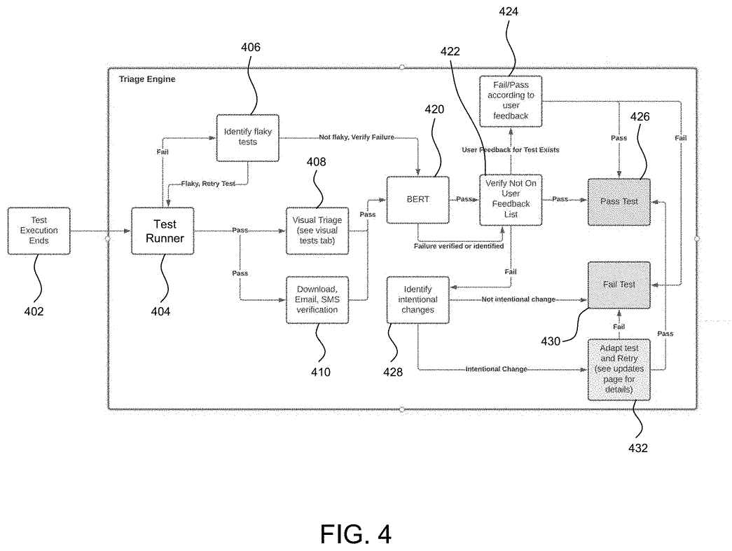

For test triage, data curation may still be used, but with a more extensive data set that includes the input operation requests, server logs, database changes, state changes, HTTP requests, and potentially other data elements. FIG. 4 illustrates an example triage engine. Once the test or test series execution has ended 402, the test runner 404 (e.g., Cypruss) can determine whether the test failed to complete or passed. If the test failed, the test can be checked to identify a flaky test 406. The definition of a flaky test is where there are problems unrelated to the process or test series during the test (e.g., network problems, server problems, operating system problems, failure due to load times, failed element locations, failures in the test runner, etc.) in contrast to a failure of the test series executed against the process. A flaky test may be identified by checking the frontend and backend outputs from the tests. In addition, the test environment can also be checked for problems. For example, the network connection, operating system, drivers, server, hardware or other related items may be probed for problems. A flaky test may be re-tried. If the test is not flaky but has failed, then the test can be run through the deep neural network model to determine where the test had proper behavior despite a failed test.

If the test has passed (e.g., completed execution properly), the test can first be visually triaged. This visual triage may include checking a series of screenshots during the text execution to make sure that the visual output was correct behavior. Such visual checks may be done at a functional level or text presentation level and are not necessarily based on pixel output. In addition, visual triage may identify areas or define area output that always, never, or sometimes change from one execution to the next in a given step or screenshot, and if the output is not consistent with the defined area output and error may be flagged.

An action checking module 410 can validate the outputs or results from a test series executed against the process such as validating that: a download occurred, an email was sent, an SMS was sent, and/or checking the contents of such actions. A message may also be sent to a user via email, SMS (simple message service) text or pub-sub messaging to notify the user that the test completed, results were finished and the test output is being or has been validated and triaged.

The output from the test can be run through a deep neural network model 420 to determine if frontend output and/or backend output follow proper behavior for the process. A BERT type model 420 may be used that is able to identify which tests fail or do not behave as expected (as opposed to only evaluating pass versus fail results).

The triage process for test results, can also combine the triage of the event trace/clickstreams/API requests, etc. or process output using the deep neural network model model(s) with the visual component triage (e.g., identifying visual differences like from screenshots, text found by OCR, identifying area that always, never or sometimes change, etc.) described earlier. This validates the outputs of the process (e.g., application) using both a machine learning test and a visual summary test or visual triage. This two-part test can provide a greater assurance that the test did execute as planned and even the user viewable output was correct.

The triage module can also check to see if user feedback exists 422 for that test result (e.g., outcome, trace of events, output, test results, etc.). If user feedback does not exist, then the test is passed 426. If user feedback does exist 424, then the feedback can be checked to see whether or not the user has flagged the test result as failing. If the test result is flagged as failing, the test will be failed 428. If the test result is flagged as passing or not flagged at all, then the test may pass 426.

The user input or flagging may be accepted as additional training or feedback for the machine learning models. For example, if a test passes and should have failed, or the test fails and should have passed, the user may mark the result as incorrect and the machine learning model for test result verification may use this information to avoid making the mistake again. The user input provides a feedback loop to identify actions the automated triage takes but these actions are incorrect. When the user feedback gets tracked, then the model learns from that feedback. Since the model can be trained on the user feedback, when the exact test series or test path for the process is seen again, the test application can pass the test series or test path that was previously passed (or vice versa).

The test application or triage engine may test to determine whether a failed test is related to a developer's change in the source code. If a failed test is related to a source code change, then it may be determined whether the changes were intentional or not. In one example, updates in source code can be compared to developer or tester actions to identify what changes in a platform that caused a test failure may be intentional and not accidental and what changes are simply defects. More specifically, a developer may be associated with making change in the source code, then the developer can interact with the process or platform along a certain functional or navigational path in the platform that aligns with the change. Therefore, the test application may determine a failed test is failing due to this intentional change by the developer.

In another configuration to identify intentional changes in a process, user stories can be automatically tied to tests. Further, user stories or tests can be tied to server logs or other logs. Data from these data sources may be compared to make sure a change that caused a test to fail was made on purpose and was not a bug. The user requirements may be input to a deep neural network model or NLP type of machine learning model to summarize the user requirement. The user requirements can then be compared to those relevant changes in the application to see if the user requirements and the change to the application are similar or not. For example, the text values from the graphical user interface of an application and the user stories can be compared to see the two aspects have similar meanings. Text-to-image models can be used on the visual screenshots of the application, and the visual screenshots can be converted into text. This may provide a text description of what was happening in the application. If the meaning of the user story in summarized form aligns with the text, functions or other output of the application, then the change in the process is an intentional change and the test may be flagged as a passing test.

After the test output has been run through the deep neural network model and a failure has been identified, the software may have checked to see if the problem was an intentional change in the process 428, as described above. If the change was intentional, then the test can be automatically adapted and retried 432. If the test fails in a retry, the test can be marked as failing but the test can be marked with a notice that the test was believed to have failed because of an intentional change and test could not be fully automatically modified to fix the test. Thus, the test will not be marked as a bug.

In order to automatically adapt a test, the system can first identify and analyze the source code (or executable code) change made by the developer. Then the triage module can determine whether there is another test by the developer or a tester who has tested the same path or a similar path associated with the same source code change. The system may identify a tester who is interacting with these same parts of the process and following a similar path as the source change. If so, the new path can be tried in the test (e.g., as a replacement segment) with the new source code updates to see if that new path fixes the test. Thus, new test paths can be used based on tests or usage the developer or tester has performed that are related to an intentional source code change. For example, a recording in a network graph of the way the developer has interacted with a new change (e.g., outside of test recording because all interactions with process may be recorded) can be determined to be correct behavior and that new behavior can be propagated throughout the automatically generated tests. This type of testing update is useful in regression testing when determining that changes made have created defects in parts of the existing tests.

The BERT type model may also identify what step is the point of failure in a test or test series. Reporting the test that failed to execute as failed may be done when the model can identify the test itself as the problem rather than the application. This may also be done by presenting the failed test steps to a BERT-like model for evaluation, and if the source of the failure appears to be a low confidence element of the test, the test will be deemed the problem rather than the application. A new test covering that element of the process may be needed, which, if successful, can help confirm the decision to report a problem with the test and not to report a defect in the process.

The triage of tests may also be improved by tracking of the text values or numerical values across different electronic pages and from the data stores to identify data relationships that should be maintained and verifying those relationships as test series are executed by the test runner. For example, in a financial application, if an account credit or debit occurs on one electronic page, then the account balance should change in the account summary area, which is a separate electronic page. If there is no expected change in the account balance, then this lack of a change is a test failure. This is a change relationship that can be tracked across multiple electronic pages. The test application can track such text or value relationships in an automated fashion, so that if the correct results are not provided, a test failure can be reported. Where a first action happens in a first area and then a second action is expected in a second area, when the second action does not occur, then the test application can report the error in the process.

The test application can also execute tests that are expected to fail by providing data that is expected to fail the tests. Such tests may be considered negative tests that should fail. Once a negative test has executed, a verification can take place that the test does indeed fail when executed. The incorrect data for the negative test may be selected automatically from other tests, other environments for the process, or by generating random data in order to build tests that are intended to fail.

In one aspect, the tests may be improved over time by using tests that were recently generated and recorded in developing and updating the process. The tests may be updated by using the most common data paths or letting the machine learning re-generate the test. In addition, a test might be better by switching two steps and the test application may detect if certain orderings of test are an improvement. Over time, tests can be updated based on newest data. The updates from newer test data may result in: reordering operations, replacing operations, removing redundancy, prioritizing the most used pathways, etc.

When a test fails, but the failure might be from an intentional change, the test may be adapted to the new update in the process. Similarly, an existing test may be adapted to cover new features, by using new developer/tester actions compared to the previous network graph of user interactions. The network graph for the process can be used to identify changes to paths and those new paths can be applied to the automatically generated tests to generate new tests or update the tests.

The test application is tracking each of the elements (e.g., button, input field, text field, any graphical element in a web application or mobile application) in the process that have been recorded as being used. However, if a new element is created for the process the test application cannot immediately autogenerate tests for the new element because the new element only exists in the development and test environment. Instead of trying to get the deep neural network model to create coverage for the new element, the test application can add new test series to the test data store using developer actions or tester actions. More specifically, an exact copy of the developer actions or tester interactions with the process (e.g., web application) can be added as a “temporary test” until the new elements that were created are seen in enough user sessions of the process for the deep neural network model to create automatically generated tests for that new element or new feature. This basically creates a test using the developer's initial interactions with the new element. Later when there is a large enough volume of interactions then the test application and deep neural network model can autogenerate more tests for the new element in the process.

### Graphical Test Coverage

Software applications, such as web applications may be contained in and executed by a web browser. The application may be in a browser sandbox for network security. Browser languages such as JavaScript do not allow an outside application to directly access the events of an iFrame. However, the present technology enables access to the test coverage of an application due to the way events are recorded within a web browser for testing and this gives access to events occurring in the application. In other words, events from the process can be intercepted, using embedded scripts, embedded libraries, embedded instrumentation, an embedded package, hooks, analytic tags and/or server logs for testing and accessing the functionality. These embedded objects allow the an outside application (e.g., a test application or other application) to track what elements have been tested in a web application. In the past, testers may have known that they had 80% test coverage but they did not know what parts of the application were actually being tested.

As a result of being able to capture the events for a process, a visual view of test coverage in the graphical user interface may be presented. For example, the process may be a web application, a desktop application, a client application, an operating system or another process. The test application enables a user to access electronic pages of the application. In each page, user interface controls, graphical areas, or output areas may be highlighted in a highlight color 510. For example, the highlight color may be a color that is not otherwise used in the graphical user interface (e.g., red, bright yellow, purple, etc.). In another example, the emphasis in the actual application for what the test covers may be bolding, images, pointers, callouts, flashing, inverted graphics, transparent overlays, pop-overs, slide outs, etc. The user may navigate through an application and see visual highlighting on or with elements of the graphical user interface that are actually covered by the test series executed by the test application. Each element may be individually highlighted with a colored box to highlight the elements the tests cover. Alternatively, the visual view may highlight user controls or viewable areas of a process that have not been tested as opposed to the areas that have been tested.

When it becomes clear to a user that a specific element has not been covered with a test, a user interface (UI) control related to element may be selected and a trigger will call a function of the test application that will generate a test using the machine learning model to cover the previously untested element. For example, a button, right click menu, callout, slide out window, or other user interface control may be placed on or with the element in the graphical user interface that has not been covered with previous testing, and the user can select the graphical user interface control to notify the test application to automatically generate tests for the untested element. These additional tests can be generated using previously recorded tests which are similar to the untested area or using recorded actions from a developer who created the new source code for the element in the graphical user interface.

The following example clause describes a method for displaying test coverage in a web application.

A method for displaying test coverage of an application in a web browser, comprising:
intercepting test events occurring while testing the application, wherein the test events are intercepted using embedded code or tags included in the application for testing purposes;
linking test events with application elements of the application;
mapping which application elements have been tested; and
highlighting on electronic pages of the application the elements that have been tested, wherein the highlighting is applying a color highlight to the application elements.

### Test Updating

The maintenance of tests can be accomplished in multiple ways after valid tests are automatically generated. Targeted updating of tests based on data connected to specific code changes is one method of test updating as described earlier. In addition, test updates may occur as code changes in real-time or based on static code analysis.

A related maintenance aspect is updating the data. Identifying what training data can still be used in training new models as an application evolves becomes increasingly important the further process (e.g., application) changes. Models may just be swapped for a clean model that is trained on only new data or data that is still valid, given the code has changed. Possibly retraining the model on the updated data may help avoid this. Finally, models can better account for language evolution. Adapting models has a more significant effect on margin than on the actual product performance, and this effect is due to lowering cloud computing costs to avoid having to retrain each model.

Testing may also occur using autonomous test selection or targeting the relevant tests to run given what code changed or in what piece of the Developer Operations (DevOps) pipeline the tests are being run. For example, if part of the dashboard code is updated, running the entire suite of tests makes little sense and is more expensive for the end-user than just running the core set of tests for essential pathways and the full suite related to the dashboard. Running a subset of tests at each code commit, a more comprehensive subset at a pull request, and a full set before code release to production or even on regular intervals can be done with the present technology. An example is running the full suite weekly if code releases happen on a weekly basis.

The present technology may be used to perform automated, machine learning based load testing. Simulating what actual surges look like or simulating a real load of users is a challenge which current load testing tools can have difficulty accomplishing. Part of the challenge is to simulate actual users realistically. This testing technology may enable more realistic load simulations for better performance testing than is currently available.

The test application also may include the ability to fix defects found by the system automatically, as described earlier. By understanding the way in which the application should behave (or functional behavior), process code can continually be updated until that behavior is met. This may include random mutations or other different techniques that are dependent on the ability to understand how the application should behave. With this, the test application can make thousands of changes to code until an approach appears to work and then present the potential fix to a developer.

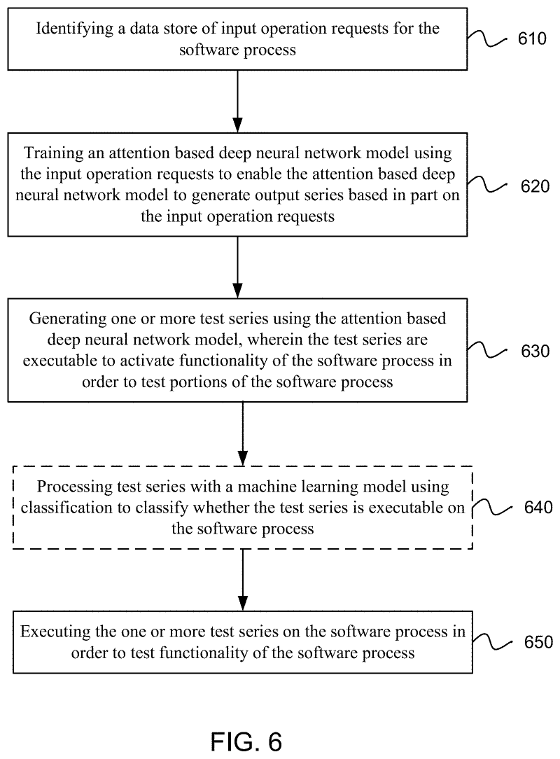

FIG. 6 is a flow chart illustrating a method for generating tests to execute against a process. The method may include the operation of identifying a data store of input operation requests for the process, as in block 610. The input operation requests may be recorded as a user operates functionality of the process. Alternatively, the inputs may be input operation requests from other processes. The input operation requests may be test input operation requests that test a defined portion of the process' functionality. In one example, the input operation requests may be time series data representing at least one of: input operation requests on a user interface, input operation requests in a graphical screen area, or API requests received from one or more other processes. The user interaction may include a series of events including events such as: clicking a button, selecting data in a drop-down list box, gaining focus on a control, navigating in a control, navigating to a control, typing in a defined field, or dragging an element in a defined way. The time series data itself may include data fields that are: a time stamp, session data, a user interface component or element being activated, a function type being applied, data to be entered, or an area of an interface being activated.

Another operation in the method may be training a deep neural network model using the input operation requests, as in block 620. The training may enable the deep neural network model to generate test series based in part on the input operation requests. In one configuration, the deep neural network model that is trained may be a transformer machine learning model or an attention based deep neural network model. In other examples, the machine learning model may be: a GPT model, a GPT-2 model, a bidirectional encoder representations from transformers model (BERT), a conditional transformer language model (CTRL), a lite BERT model (ALBERT), the universal language model fine-tuning (ULMFiT), a transformer architecture, embeddings from language models (ELMo), recurrent neural nets (RNNs), or convolutional neural nets (CNNs).

One or more test series may then be generated using the deep neural network model, as in block 630. The test series may be executable to activate functionality of the process in order to test portions of the process.

An automatically generated test series may be processed with a machine learning model using classification to determine whether the test series is executable on the process, as in optional block 640. In another configuration, a test series may be classified to determine whether the test series represents correct process behavior. The test series then may be executed on the process in order to test the functionality of the process, as in block 650.

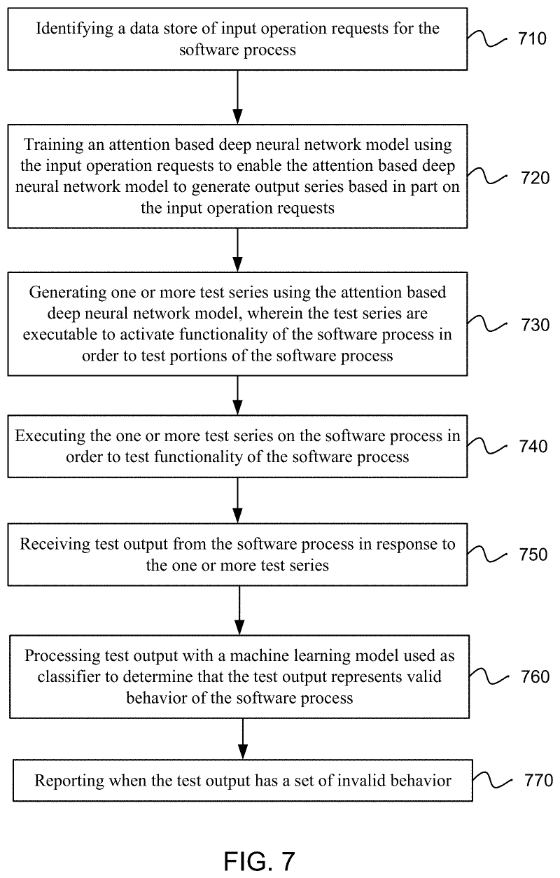

FIG. 7 illustrates a flow chart of operations stored in a non-transitory computer-readable medium which implement automatic generation of tests to execute on a process. The operations may identify a data store of input operation requests for the process, as in block 710. A deep neural network model may be trained using the input operation requests to enable the deep neural network model to generate output series based in part on the input operation requests, as in block 720. Then one or more test series may be generated using the deep neural network model, as in block 730. In addition, the test series may be executed on the process in order to test functionality of the process, as in block 740.

Test output from the process may be received in response to the execution of the test series, as in block 750. For example, the output may be process output that is graphical output, text output, database requests, API requests, logs, etc.

The test output may be processed with a machine learning model used as classifier to determine whether the test output represents valid behavior of the process, as in block 760. The system may report when the test output has invalid behavior (or inversely valid behavior), as in block 770. For example, a pass or fail notification may be reported by the machine learning model used as a classifier. The machine learning model may be a deep neural network model (e.g., BERT), a regression machine learning model, or another type of machine learning model classifier.

In one example configuration, the test output may be received from a frontend of the process in response to execution of a test series. The frontend of the software may be a graphical user interface, a command line interface, any interface that responds to a calling process (e.g., an API interface), etc. Alternatively, the test output may be received from a backend of the process in response to execution of a test series. The test output from the backend may be API calls to backend servers, data written to logs, data written to data stores, DOM (document object model) updates, POM (page object model) updates, remote function calls, HTTP requests or similar backend operations. The test output maybe processed with a machine learning model used as classifier to determine whether the test output represents valid behavior of the process.

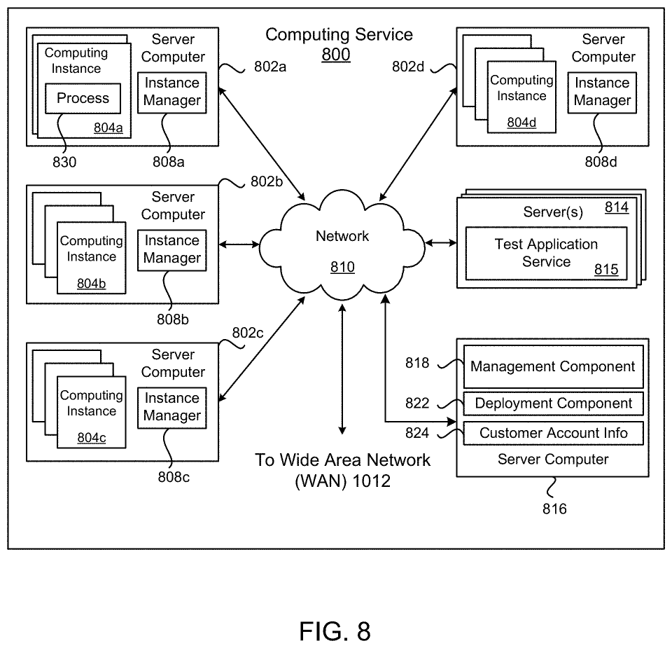

FIG. 8 is a block diagram illustrating an example computing service 800 that may be used to execute and manage a number of computing instances 804a-d upon which the present technology may execute. In particular, the computing service 800 depicted illustrates one environment in which the technology described herein may be used. The computing service 1000 may be one type of environment that includes various virtualized service resources that may be used, for instance, to host computing instances 804a-d.

The computing service 800 may be capable of delivery of computing, storage and networking capacity as a software service to a community of end recipients. In one example, the computing service 800 may be established for an organization by or on behalf of the organization. That is, the computing service 800 may offer a “private cloud environment.” In another example, the computing service 800 may support a multi-tenant environment, wherein a plurality of customers may operate independently (i.e., a public cloud environment). Generally speaking, the computing service 800 may provide the following models: Infrastructure as a Service (“IaaS”) and/or Software as a Service (“SaaS”). Other models may be provided. For the IaaS model, the computing service 800 may offer computers as physical or virtual machines and other resources. The virtual machines may be run as guests by a hypervisor, as described further below.

Application developers may develop and run their software solutions on the computing service system without incurring the cost of buying and managing the underlying hardware and software. The SaaS model allows installation and operation of application software in the computing service 800. End customers may access the computing service 800 using networked client devices, such as desktop computers, laptops, tablets, smartphones, etc. running web browsers or other lightweight client applications, for example. Those familiar with the art will recognize that the computing service 800 may be described as a “cloud” environment.

The particularly illustrated computing service 800 may include a plurality of server computers 802a-d. The server computers 802a-d may also be known as physical hosts. While four server computers are shown, any number may be used, and large data centers may include thousands of server computers. The computing service 800 may provide computing resources for executing computing instances 804a-d. Computing instances 804a-d may, for example, be virtual machines. A virtual machine may be an instance of a software implementation of a machine (i.e., a computer) that executes applications like a physical machine. In the example of a virtual machine, each of the server computers 802a-d may be configured to execute an instance manager 808a-d capable of executing the instances. The instance manager 808a-d may be a hypervisor, virtual machine manager (VMM), or another type of program configured to enable the execution of multiple computing instances 804a-d on a single server. Additionally, each of the computing instances 804a-d may be configured to execute one or more applications.

A server 814 may be reserved to execute software components for implementing the present technology or managing the operation of the computing service 800 and the computing instances 804a-d. For example, the server 814 or computing instance may include the test application service 815. In addition, the computing service may include the process 830 to be tested that is executing on a computing instance 804a or in a virtual machine.

A server computer 816 may execute a management component 818. A customer may access the management component 818 to configure various aspects of the operation of the computing instances 804a-d purchased by a customer. For example, the customer may setup computing instances 804a-d and make changes to the configuration of the computing instances 804a-d.

A deployment component 822 may be used to assist customers in the deployment of computing instances 804a-d. The deployment component 822 may have access to account information associated with the computing instances 804a-d, such as the name of an owner of the account, credit card information, country of the owner, etc. The deployment component 822 may receive a configuration from a customer that includes data describing how computing instances 804a-d may be configured. For example, the configuration may include an operating system, provide one or more applications to be installed in computing instances 804a-d, provide scripts and/or other types of code to be executed for configuring computing instances 804a-d, provide cache logic specifying how an application cache is to be prepared, and other types of information. The deployment component 822 may utilize the customer-provided configuration and cache logic to configure, prime, and launch computing instances 804a-d. The configuration, cache logic, and other information may be specified by a customer accessing the management component 818 or by providing this information directly to the deployment component 822.

Customer account information 824 may include any desired information associated with a customer of the multi-tenant environment. For example, the customer account information may include a unique identifier for a customer, a customer address, billing information, licensing information, customization parameters for launching instances, scheduling information, etc. As described above, the customer account information 824 may also include security information used in encryption of asynchronous responses to API requests. By “asynchronous” it is meant that the API response may be made at any time after the initial request and with a different network connection.

A network 810 may be utilized to interconnect the computing service 800 and the server computers 802a-d, 816. The network 810 may be a local area network (LAN) and may be connected to a Wide Area Network (WAN) 812 or the Internet, so that end customers may access the computing service 800. In addition, the network 810 may include a virtual network overlaid on the physical network to provide communications between the servers 802a-d. The network topology illustrated in FIG. 8 has been simplified, as many more networks and networking devices may be utilized to interconnect the various computing systems disclosed herein.

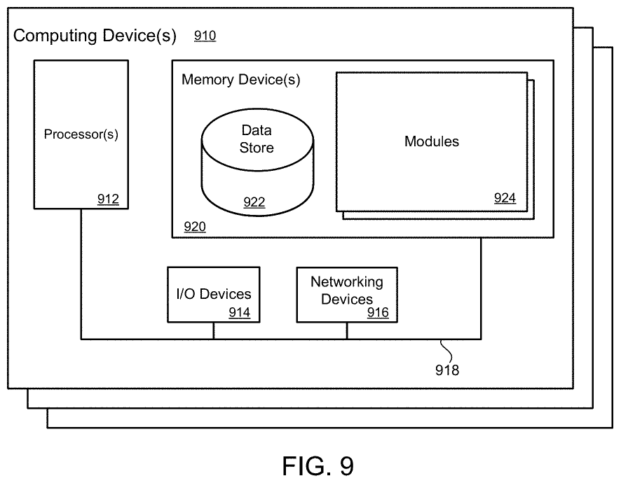

FIG. 9 illustrates a computing device 910 which may execute the foregoing subsystems of this technology. The computing device 910 and the components of the computing device 910 described herein may correspond to the servers and/or client devices described above. The computing device 910 is illustrated on which a high-level example of the technology may be executed. The computing device 910 may include one or more processors 912 that are in communication with memory devices 920. The computing device may include a local communication interface 918 for the components in the computing device. For example, the local communication interface may be a local data bus and/or any related address or control busses as may be desired.

The memory device 920 may contain modules 924 that are executable by the processor(s) 912 and data for the modules 924. For example, the memory device 920 may include an inflight interactive system module, an offerings subsystem module, a passenger profile subsystem module, and other modules. The modules 924 may execute the functions described earlier. A data store 922 may also be located in the memory device 920 for storing data related to the modules 924 and other applications along with an operating system that is executable by the processor(s) 912.

Other applications may also be stored in the memory device 920 and may be executable by the processor(s) 912. Components or modules discussed in this description that may be implemented in the form of software using high programming level languages that are compiled, interpreted or executed using a hybrid of the methods.

The computing device may also have access to I/O (input/output) devices 914 that are usable by the computing devices. An example of an I/O device is a display screen that is available to display output from the computing devices. Other known I/O device may be used with the computing device as desired. Networking devices 916 and similar communication devices may be included in the computing device. The networking devices 916 may be wired or wireless networking devices that connect to the internet, a LAN, WAN, or other computing network.

The components or modules that are shown as being stored in the memory device 920 may be executed by the processor 912. The term “executable” may mean a program file that is in a form that may be executed by a processor 912. For example, a program in a higher-level language may be compiled into machine code in a format that may be loaded into a random-access portion of the memory device 920 and executed by the processor 912, or source code may be loaded by another executable program and interpreted to generate instructions in a random-access portion of the memory to be executed by a processor. The executable program may be stored in any portion or component of the memory device 920. For example, the memory device 920 may be random access memory (RAM), read only memory (ROM), flash memory, a solid-state drive, memory card, a hard drive, optical disk, floppy disk, magnetic tape, or any other memory components.

The processor 912 may represent multiple processors and the memory 920 may represent multiple memory units that operate in parallel to the processing circuits. This may provide parallel processing channels for the processes and data in the system. The local interface 918 may be used as a network to facilitate communication between any of the multiple processors and multiple memories. The local interface 918 may use additional systems designed for coordinating communication such as load balancing, bulk data transfer, and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom Very Large Scale Integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, electrically erasable programmable read-only memory (EEPROM), flash memory or other memory technology, compact disc read-only memory (CD-ROM), digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Reference was made to the examples illustrated in the drawings, and specific language was used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

In describing the present technology, the following terminology will be used: The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” means quantities, dimensions, sizes, formulations, parameters, shapes and other characteristics need not be exact, but can be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations including, for example, tolerances, measurement error, measurement accuracy limitations and other factors known to those of skill in the art, can occur in amounts that do not preclude the effect the characteristic was intended to provide.

Furthermore, where the terms “and” and “or” are used in conjunction with a list of items, they are to be interpreted broadly, in that any one or more of the listed items can be used alone or in combination with other listed items. The term “alternatively” refers to selection of one of two or more alternatives, and is not intended to limit the selection to only those listed alternatives or to only one of the listed alternatives at a time, unless the context clearly indicates otherwise. The term “coupled” as used herein does not require that the components be directly connected to each other. Instead, the term is intended to also include configurations with indirect connections where one or more other components can be included between coupled components. For example, such other components can include amplifiers, attenuators, isolators, directional couplers, redundancy switches, and the like. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples. As used herein, a “set” of elements is intended to mean “one or more” of those elements, except where the set is explicitly required to have more than one or explicitly permitted to be a null set.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method for generating tests to execute against a process, comprising:
identifying a data store of input operation requests for the process, wherein the input operation requests are recorded as requests are received to operate functionality of the process;
training a deep neural network model using the input operation requests to enable the deep neural network model to generate test series based in part on the input operation requests;
generating one or more test series using the deep neural network model, wherein the test series are executable to activate functionality of the process and test portions of the process; and
executing the one or more test series on the process in order to test the functionality of the process.

2. The method as in claim 1, wherein the input operation requests include time series data representing at least one of: input operation requests for a user interface, input operation requests captured graphically for a screen area, or API requests received from another process.

3. The method as in claim 2, further comprising capturing time series data that includes data fields that are at least one of: a time stamp, session data, a user interface component being activated, a function type being applied, data to be entered, or an area of an interface being activated.

4. The method as in claim 1, wherein the input operation requests are test input operation requests that test a defined portion of the process' functionality.

5. The method as in claim 1 wherein the input operation requests are user interactions that have a series of events including events selected from at least one of: clicking a button, selecting data in a drop-down list box, selecting data in a grid, gaining focus on a control, navigating in a control, navigating to a control, typing in a defined field, or dragging an element in a defined way.

6. The method as in claim 1, further comprising training the deep neural network model that is a transformer-based machine learning model or an attention based deep neural network model.

7. The method as in claim 1, further comprising training a machine learning model that is at least one of: a GPT model, a GPT-2 model, a bidirectional encoder representations from transformers model (BERT), a conditional transformer language model (CTRL), a lite BERT model (ALBERT), a universal language model fine-tuning (ULMFiT), a transformer architecture, embeddings from language models (ELMo), recurrent neural nets (RNNs), or convolutional neural nets (CNNs).

8. The method as in claim 1, further comprising processing a test series with a machine learning model using classification to classify whether the test series is executable on the process.

9. A system to automatically generate tests to execute on a process, comprising:
a data store of input operation requests for the process, which have been recorded as at least one user utilizes functionality of the process;
a deep neural network model that is trained using the input operation requests;
a test generator to generate one or more test series using the deep neural network model, wherein the one or more test series are executable to activate functionality of the process and to test portions of the process; and
a test validator to validate the one or more test series with a machine learning model used as a classifier to classify whether a test series is executable on the process; and
a test executor to execute validated test series to test functionality of the process.

10. The system as in claim 9, further comprising:
determining an execution probability for a test series; and
validating the test series with an execution probability that is above a test execution threshold value.

11. The system as in claim 9, further comprising executing a test on the process to determine validity based on whether the test executes.

12. The system as in claim 9, wherein the input operation requests are user test series that test a portion of the process' functionality as recorded from a user during a testing session.

13. The system as in claim 9, further comprising capturing input operation requests that are time series data which includes data fields that are at least one of: a time stamp, session data, a user interface component being activated, a function type being applied, data to be entered, or an area of an interface being activated.

14. The system as in claim 9, further comprising recording input operation requests in a user interaction session that represent user interaction events with graphical controls or command line controls of a user interface of the process.

15. The system as in claim 9, further comprising training a deep neural network model that is a transformer-based machine learning model or an attention based deep neural network model.

16. The system as in claim 9, further comprising training a machine learning model that is at least one of: a GPT model, a GPT-2 model, a bidirectional encoder representations from transformers model (BERT), a conditional transformer language model (CTRL), a lite BERT model (ALBERT), a universal language model fine-tuning (ULMFiT), a transformer architecture, embeddings from language models (ELMo), recurrent neural nets (RNNs), or convolutional neural nets (CNNs).

17. The system as in claim 9, further comprising:
recording backend operations initiated by the process as sent to backend servers providing services to the process; and
processing the backend operations using a transformer based artificial intelligence model to determine that the backend operations is valid behavior for the process.

18. The system as in claim 17, wherein the backend operations are at least one of: API calls, server log entries, data store updates, DOM (document object model) updates, POM (page object model) updates, remote function calls, or HTTP requests.

19. A non-transitory computer-readable medium comprising computer-executable instructions which implement automatic generation of tests to execute on a process, comprising:
identifying a data store of input operation requests for the process, which have been recorded as requests are received to operate functionality of the process;
training a deep neural network model using the input operation requests to enable the deep neural network model to generate output series based in part on the input operation requests;
generating one or more test series using the deep neural network model, wherein the test series are executable to activate functionality of the process in order to test portions of the process;
executing the one or more test series on the process in order to test functionality of the process;
receiving test output from the process in response to the one or more test series;
processing test output with a machine learning model used as classifier to determine that the test output represents valid behavior of the process; and
reporting when the test output has a set of invalid behavior.

20. The non-transitory computer-readable medium as in claim 19, further comprising:
receiving test output from a front end of the process in response to execution of a test series;
processing test output with a machine learning model used as classifier to determine whether the test output represents valid behavior of the process; and
reporting whether the test output was valid.

21. The non-transitory computer-readable medium as in claim 19, further comprising:
receiving test output from a backend of the process in response to execution of a test series;
processing test output with a machine learning model used as classifier to determine whether the test output represents valid behavior of the process; and
reporting whether the test output was valid.

22. The non-transitory computer-readable medium as in claim 19, further comprising:
receiving input operation requests for a test for the process;
receiving test output that includes output events resulting from a test for the process;
processing the input operation requests and output events with a machine learning model used as classifier to determine whether the input operation requests and output events represent valid behavior for inputs to the process; and
reporting whether the input operation requests and the test output are valid.

23. The non-transitory computer-readable medium as in claim 19, further comprising:
tracking API calls from the process to backend servers in communication with the process; and
processing the API calls with a machine learning model used as classifier to determine that the API calls represent valid behavior of the process.

24. The non-transitory computer-readable medium as in claim 19, further comprising:
tracking HTTP requests or server log writes from the process to backend servers in communication with the process; and
processing the HTTP requests or server log writes with a machine learning model used as classifier to determine that the API calls represent valid behavior of the process.

25. The non-transitory computer-readable medium as in claim 19, further comprising:
determining that a test failed; and
comparing updates in source code to developer or tester actions to determine that changes are intentional and are not defects.

26. The non-transitory computer-readable medium as in claim 19, further comprising analyzing visual images from the process to determine whether a test has passed.

27. The non-transitory computer-readable medium as in claim 26, further comprising analyzing at least one of: text, user interface controls, or images in a visual image of the process.

28. The non-transitory computer-readable medium as in claim 19, further comprising:
summarizing user stories or product requirements for a process using a deep neural network model to generate summarized product functionality;
converting visual output of the process to text to form a visual summary of the process; and
comparing the summarized product functionality with the visual summary to determine whether a test failure was intentional.

29. The non-transitory computer-readable medium as in claim 19, further comprising:
tracking of text values or numerical values across a plurality of electronic pages or a plurality of data stores to identify data relationships to be maintained; and
verifying whether the data relationships were maintained using a test series executed by a test runner.

30. The non-transitory computer-readable medium as in claim 19, comprising:
identifying a failure of a test;
checking whether a failure of a test was due to an intentional change;
adapting the test when the change is identified as intentional change;
retrying the test; and
marking the test that failed in a retry as the test that failed due to an intentional change and the test was not able to be modified to fix the test.
